(19) United States
(12) Patent Application Publication
(10) Pub. No.: US 2014/0151616 A1
(43) Pub. Date: Jun. 5, 2014

(54) MEDIUM TRAVERSE

(71) Applicants: Brenda G. Carroll, Quitman, GA (US); Walter M. Carroll, Quitman, GA (US)

(72) Inventors: Brenda G. Carroll, Quitman, GA (US); Walter M. Carroll, Quitman, GA (US)

(21) Appl. No.: 13/931,800

(22) Filed: Jun. 28, 2013

Related U.S. Application Data
(60) Provisional application No. 61/665,403, filed on Jun. 28, 2012.

(51) Int. Cl. H02G 1/04

(52) U.S. Cl. CPC H02G 1/04
USPC 254/134.3 R

(57) ABSTRACT

A system is provided for installing a cable across a medium. The medium traversal system comprises troughs that are connected end to end by connecting bracket and pins. The troughs include opposing sides connected by a bottom surface that form an elongate channel for supporting the traversal and installation of a cable over a medium such as a roadway. The troughs are suspended from a messenger wire by a detachable rolling mechanism that is attached to the sides of the troughs. The troughs are removed by reversing the order of installation. During removal, a lasher is wound around the cable and messenger wire to secure the cable.

### PRIORITY CLAIM

This application claims priority and benefit of the U.S. Provisional Patent Application No. 61/665,403 filed on Jun. 28, 2012 by Brenda G. Carroll.

### FIELD OF THE INVENTION

The present invention relates to apparatus for installing utility cables aerially supported by poles on opposing sides of a medium such as a roadway, and more particularly, to an apparatus for temporarily supporting a utility cable above a medium while being drawn across the medium.

### BACKGROUND OF THE INVENTION

Utility companies and other authorities often perform a rolling road block to enable workers the time to pull a cable across a roadway or other medium. During the road block, such cable is hung across the medium, and a lashing wire is wrapped around the cable to support it between poles on both sides of the medium. Slowing traffic is a persistent problem with rolling road blocks. Such traffic is generally traveling at high rates of speed and then suddenly slows to a crawl to accommodate the road blocks, which poses a safety hazard. The rolling road blocks are done to allow a break in traffic to grow and create a space where there is no traffic for a certain length of time while cable is installed across the medium.

Though some previous attempts have been made to eliminate the practice of rolling road blocks, it still persists. One such attempt in provided in U.S. Pat. No. 6,595,492 that discloses a method for directing cable across an obstacle. The features disclosed include assembling tubular members together in tandem and suspending the members to a wire. Aerial cable is installed by pulling the cable through several cable holding cylinders that are attached to the tubular members. A more flexible system is needed than provided by Penna in U.S. Pat. No. 6,595,492.

Other attempts include U.S. Pat. No. 6,227,522 to Chikiri and Hagashi that discloses a method of installing spiral hangers for hanging a cable on a messenger wire. The method requires a separate guidance implement and a pull-rope threading implement. U.S. Pat. No. 4,421,301 to Chapman discloses an apparatus and method for stringing a cable using an aircraft and a hoist line. U.S. Publication No. 2011/0001100 to Ogawa and Matsuo disclose a tool and method for installing cable that includes a plurality of S-shaped guides. A connection rope connects the plurality of S-shaped guides and a towrope that is bound to an end of the connection rope

Unfortunately, these attempts to solve the problem of installing a cable across a medium involve tradeoffs with regard to flexibility, cost or ease of use.

Therefore, it would be desirable to have a better system for installing utility cables aerially supported across a roadway or other medium.

### SUMMARY OF THE INVENTION

A series of elongate troughs have opposing sides connected together by a bottom surface to define an elongate top opening of a channel. The troughs connect together with connecting brackets and roll across a suspended cable across a major highway or other medium in order to support and pull a cable, such as a copper cable, fiber optic cable or coaxial cable across the medium safely without endangering or hindering traffic in any way. The system of troughs, each for example about 10 feet long, is attached one after the other to traverse the roadway or like until a complete trough system is formed for passing a cable therein. The cable is passed from one side of the roadway to the other side using the trough being drawn by a rope or such.

After the cable is crossed, a lashing is attached via a winding device, referred to as a “Lasher”, to a first end of a trough and is brought across with the disassembly of the trough. While crossing, the lashing is wound about both the cable and the steel support cable for permanent support of the cable. One person at each end of the wire is positioned to complete the operation without hindering traffic.

The troughs include a rolling mechanism that is easily detachable from at least one side of the trough for efficient connection to a messenger wire.

An object of the invention is to provide a safe method to install cable across a roadway without the need to institute rolling road blocks by making available to engineers a device and tools that can be used for traversing a highway with a cable without hindering traffic.

Another object is to provide a system for installing cable that is easy to use and flexible for use with a variety of cable types, sizes and weights.

Yet another object is to provide an aerially support system that is lightweight yet strong enough to support a cable approximately 5 lbs/foot.

Still another object is to provide a medium traverse system for cable that can be used by telephone companies, television providers, cable companies, and municipal organizations for installing new cable.

### BRIEF DESCRIPTION OF THE DRAWINGS

FIG. 1 is a side elevation view of a medium traversal system assembled in accordance with an embodiment of the invention.

FIG. 2A is a perspective view of a trough with roller assembly in accordance with an embodiment of the invention with a portion of the view exploded to illustrate particular features of the invention.

FIG. 2B is a perspective view of a trough with roller assembly in accordance with another aspect of the invention.

FIG. 3 is a side elevation view of a roller assembly on a second end B of a trough as shown in FIG. 2A.

FIG. 4 is a side elevation view of a roller assembly on a first end A of the trough shown in FIG. 2B.

FIG. 5 is a sectional view of FIG. 1 illustrating the connecting bracket connecting two troughs together.

FIG. 6 is a cross-sectional view of the roller assembly along line 6-6 of FIG. 5.

FIG. 7 is side elevation sectional view of FIG. 1 illustrating the

### DETAILED DESCRIPTION

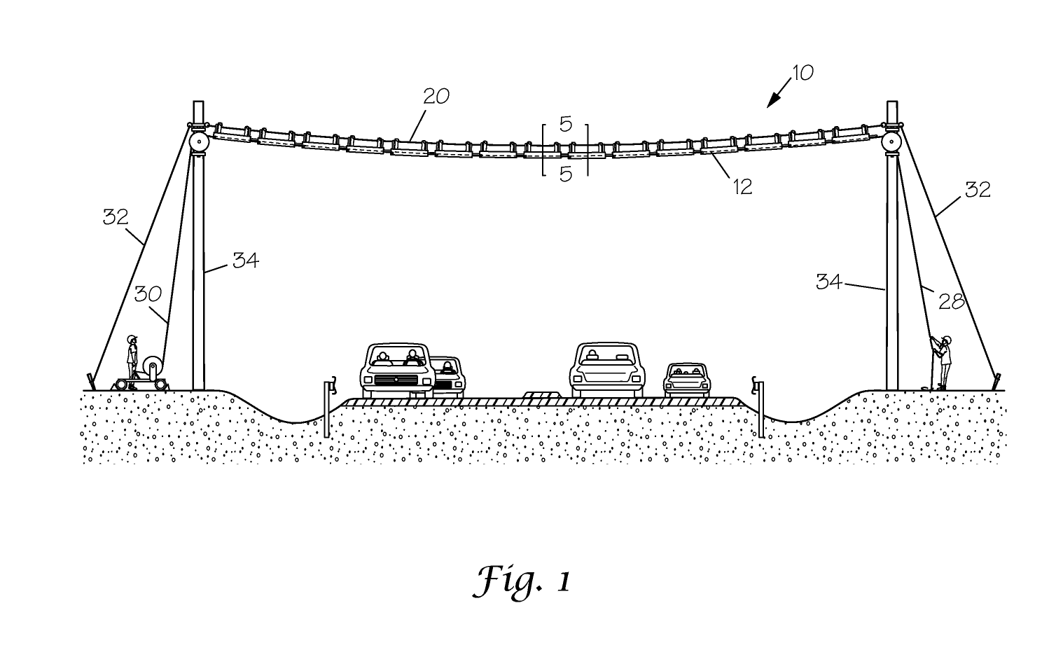

Referring now to FIG. 1, an elevation view of an assembled aerial cable installing system 10 according to an illustrative embodiment of the invention is shown.

The aerial cable installing apparatus 10 of the invention comprises an assembly of elongate troughs 12 arranged end to end. The troughs 12 provide multiple connected sections of a system of troughs that are connected together in tandem by connecting brackets 14 that permit adjacent troughs to bend slightly relative to one another thereby providing the system 10 with a degree of flexibility over a wide variety of assembled lengths. The system 10 can be easily assembled to virtually any desired length by merely assembling the appropriate number of troughs together. A plurality of rolling mechanisms 16 include suspension rollers 18 attached to each of the troughs 12. The rolling mechanisms 16 enable the troughs 12 to be suspended from a cable, such as a steel support or messenger cable or wire 20, whereby the troughs are movable along the wire by rolling there along. The rolling mechanism 16 is attached above and opposing the top opening of the trough, and the rolling mechanism is detachable from the trough. The troughs 12 include an elongate depression or hollow between two elongate sides 22 and 24, whereby the depression of the troughs accommodate an aerial cable 26 to be installed using the system by sliding the cable through the troughs.

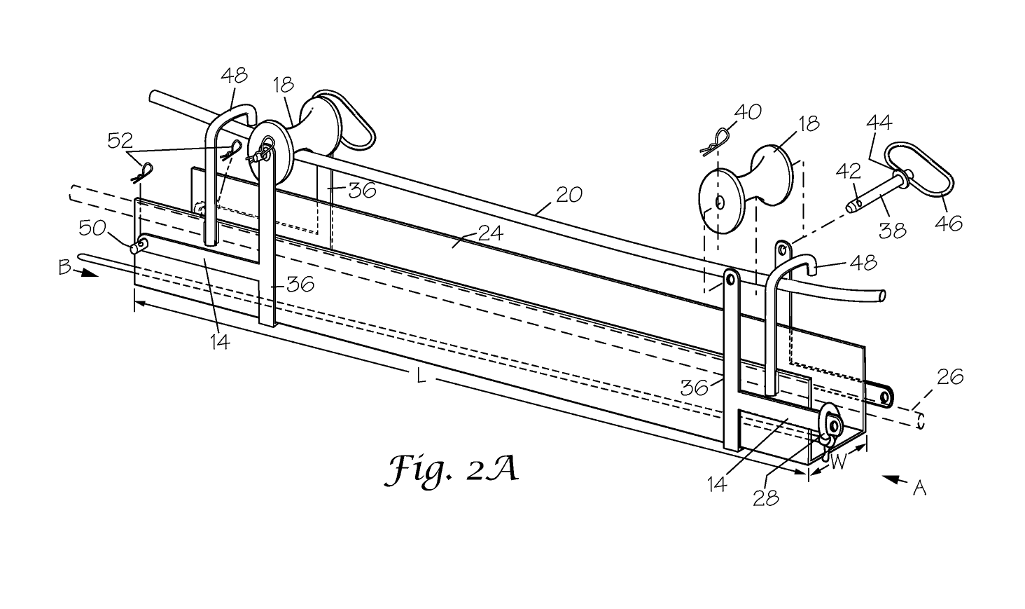

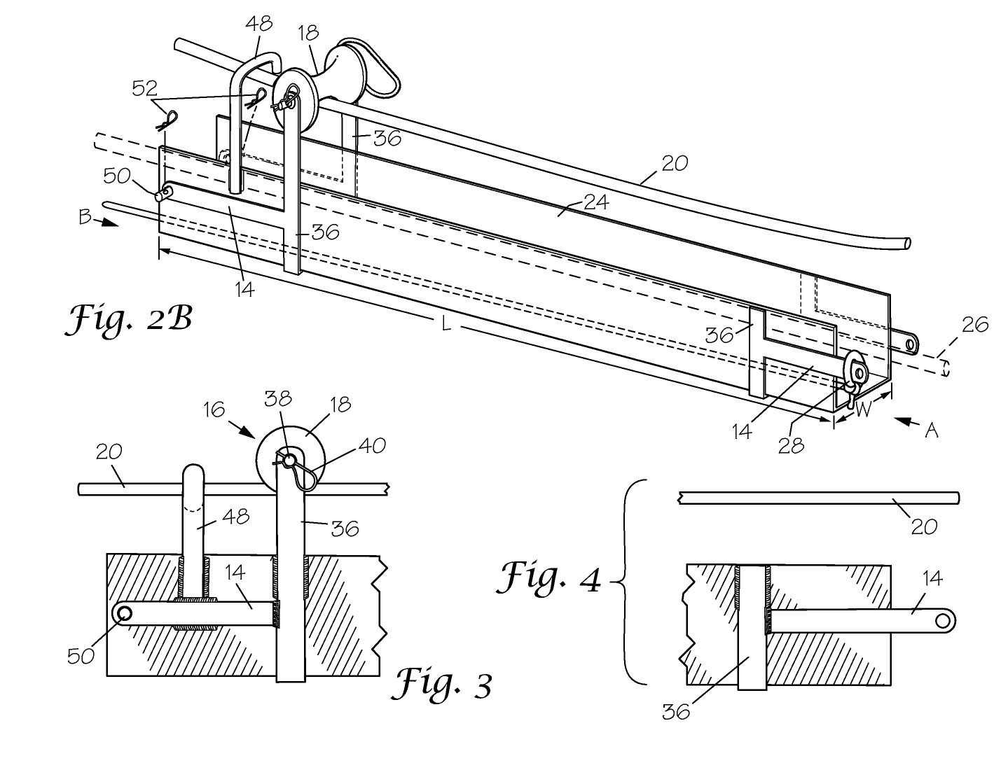

Also, as shown in FIGS. 1 and 2, the troughs 12 are generally equal in length “L”, typically a few feet long, having a trough width from side to side “W” of several inches, and are made from a substantially rigid, electrically insulative material such as plastic that can support up to 5 lbs per foot of aerial cable. Each trough has opposing sides connected by a bottom surface, and the sides extend upward from the bottom surface to an opposing top edge of each side. The top edges define an elongate top opening of a channel along the length of the trough.

Referring again to FIG. 1, a pull rope 28 attaches to the leading end A of the trough 24 to be pulled across and traverse the medium so that the pull rope can be used to draw the cable along through the troughs as the system is suspended on an associated messenger cable 20. The pull rope 28 is constructed for easy movement through the troughs 12. The pull rope is adapted to attach to the leading end of the cable 26 for pulling. When pulling force is applied to the cable by the pull rope, the cable is moved through the plurality of troughs in the system 10. Although a pull rope is shown in the embodiment for initiating and moving the cable through the troughs, it should be understood that other types of cable or wire pulling means can be used for this purpose if desired. The pull rope will haul the aerial cable from a resource of cable provided, such as the reel 30 of cable depicted in FIG. 1. Such reel may be provided from a reel truck in large heavy quantity and reeled from there by the pull rope 28. Such reel 30 may provide any desired source of aerial cable as may often be used in traversing obstacles such as highways. These types of aerial cable 26 include telephone cable, fiber optic cable, television coaxial cable, electrical cable, and other types of cable or flexible elongate aerial medium as desired.

A tensioned guy-wire or guy-rope 32, also known as simply a guy, may be provided as shown in FIG. 1 to add stability to structure of the system, which includes a post or mast 34 on each end connected by the messenger wire 20 and a pulley wheel 64 for movement and support of cable 28. One end of each guy 32 is attached to the respective post 34, and the other end of the guy is anchored to the ground at a distance from the post's base. For a shorter or studier structural post, only a single guy wire may be required. However, for a large system, it is understood that more than one guy may be connected to each post radially about the post to allow the tension of each guy-wire to offset the others.

Referring again to FIGS. 2A and 2B, each of the suspension rollers 18 comprises a release mechanism for the roller 18. The rollers 18 are removed for placement of each trough 12 onto the messenger wire 20 by inserting the wire into the trough between roller brackets 36 consisting of bars attached to the trough. In the particular embodiment, the brackets 36 form a clevis as part of a three piece fastener system of a clevis, clevis pin, and cotter pin for retention of the roller.

The release mechanism shown in the embodiment of FIG. 3 includes a roller pin 38 that may consist of an appropriate size unthreaded clevis pin as depicted in FIGS. 2A and 2B. The roller pin 38 provides an axle for the roller 18 to rotate about during movement of the trough 12. The roller 18 includes an elongate axial aperture through the center of the roller, and the roller pin 38 is secured within the aperture by insertion through the aperture and provision of a cotter pin 40 inserted through a pin hole 42 of the roller pin 38. Thereby, on one end of the roller pin 38 is provided a retaining washer 44 and loop 46 abutting against a side of the roller 18 and on the opposing end of the roller pin 38 is provided the cotter pin 40 through the pin hole 42 beside the opposing side of the roller bracket 36.

The troughs 12 as shown in FIGS. 2A and 2B include a hanger 48. In FIG. 2A, the hanger is placed on each end for temporarily hanging the trough on the messenger wire 20. In FIG. 2B, the hanger is only needed on the B end, as the A end will attached to the first trough shown in FIG. 2A. The hanger 48 provides a convenient means to retain the trough 12 on the messenger wire 20 while one trough is connected to the next in series and while the suspension rollers 18 of each trough are connected over the messenger wire. This process is repeated until the selected number of troughs is installed on the messenger wire.

Referring now to FIG. 2B and FIG. 3, the bracket 36 for retaining the roller 18 and the roller pin 38 as shown is integrated into the individual trough 12 on each B end, referred to also as the second end of the trough. Each roller 18 is attached to a bracket 36 above the top of the troughs 12. Before being attached the roller 18 and pin 38 are removed from the bracket 36, and the trough 12 is hung from the messenger wire 20 by inserting the pin 38 through the roller 18 while the roller is positioned above the messenger wire. In the embodiment shown in FIG. 3, the roller bracket 36 it is situated on the left hand side of the trough 12. First the first trough, as shown in FIG. 2A, an additional roller bracket 36 is situated on the opposing right hand end of the trough 12, as this first trough will traverse across the messenger wire and needs roller wheel support on both the first and second ends of the trough. The pair of roller brackets 36 acts together to provide opposing prongs of a clevis or U-shaped member to support the each of the rollers 18. The set of opposing rollers 18 attached to the B end of each trough supports each trough 12 on the messenger wire 20 and allows the respective troughs to roll on the wire and move into position as more troughs are added onto the messenger wire. Each connecting bracket 14 as shown in FIGS. 3 and 4 may be attached to an adjoining roller bracket 36 on the B end of the troughs for mutual reinforcement of both the roller bracket and the connecting bracket.

Referring now to FIG. 4, the connecting bracket 14 is shown on the opposing first end of the trough, shown as end A in FIG. 2B. In the example shown, the left-hand connecting bracket on the second end B is recessed from the end of the trough as shown in FIG. 3. Whereas, the opposing connection bracket 14 on the first right-hand end A of the trough 12 extends outward from the opposing end of the trough for coupling with a recessed connecting bracket of a second trough via a pin 50 the extends from the side wall (22 and 24) of the trough or related bracket. An aperture on the connecting bracket 14 receives the pin 50 into an aperture within the arm of the bracket. A cotter pin 52 retains the pin within the arm of the bracket 14 to connect the opposing ends of links troughs 12. A small amount of spacing between the linked troughs permits the connected troughs to pivot with respect to each other on the connection between the pin and connecting bracket and conform to the curvature of the messenger wire 20 for easy traversal across the medium.

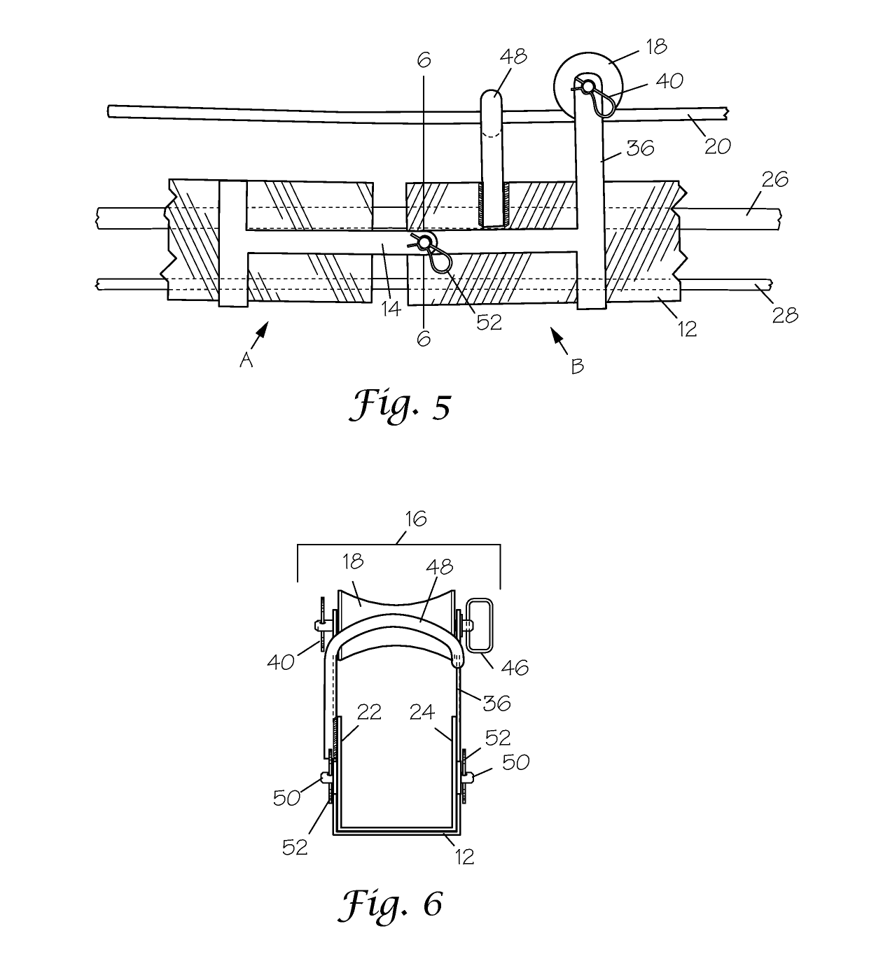

When a second and subsequent trough 12 is installed on a messenger wire, the troughs are connected together using the connecting brackets 14 as shown in FIG. 5. A simple and efficient means should be provided for attaching the connecting brackets, in an alternative embodiment shown these brackets are connected by overlapping the connecting bracket parts and inserting a clevis pin or bolt through the overlapping apertures to function as a pin to secure the brackets. The connection between the brackets allows the troughs to flex with respect to one another and to match the curvature of the messenger wire that is crossing a roadway.

FIG. 6 shows a cross sectional view of a trough 12 with the roller assembly 16. As shown the trough 12 includes a depression through which one or more cables 26 can be inserted and run across a roadway through the system 10 of troughs. The space between the bottom 54 of the trough and the roller 18 allows cable of various sizes to be used with the trough system. The side walls 22 and 24 of the troughs 12 contain the cable 26 so that the cable does not fall from the trough, while maximizing in the utility of the system for a variety of cable.

The system shown in the preferred embodiment minimizes the number of parts needed in the cable traversal system by incorporating the roller by attachment to the side walls of the trough with a bracket or clevis. While the present embodiments provide a clevis pin and cotter pin to attach the roller to the prongs of the bracket, this element or feature and other features of the invention might the improved through further refinement or modification without varying from the spirit and scope of the invention.

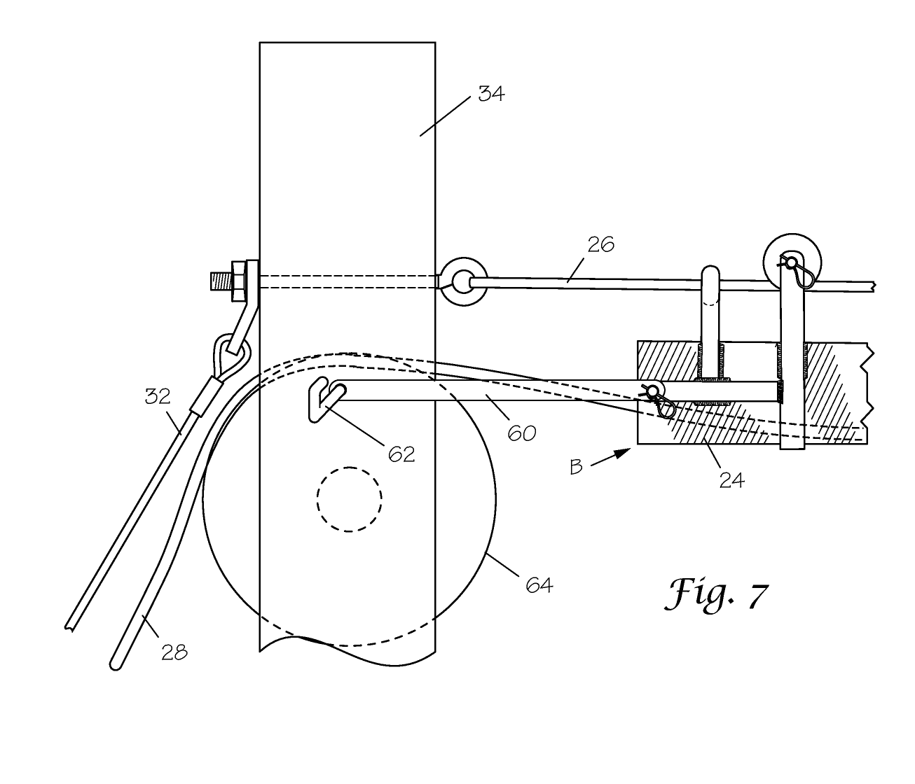

The pole 34 on a first side of the roadway situated for feeding cable is shown in FIG. 7 includes a J-hook 62 attached to or driven into the pole near the top of the pole below the attached messenger wire 20. The J-hook supports the B end of the last trough installed on the messenger wire via a stabilizer bar 60 attached between the bracket 14 on trough and the J-hook 62 on the pole. A cotter pin is inserted to secure the stabilizer bar to the bracket and the shape of the J-hook secures the opposing end of the stabilizer bar. The attachment of the stabilizer bar 60 to the feeder pole 34 secures the trough system against the resistance caused by the movement of cable 26 sliding through the troughs.

The trough system is installed beginning from the pole 34 that is situated for feeding the cable 26. A first trough 12 with additional roller bracket 36 and hanger 48 as shown in FIG. 2A is hung on the messenger wire 20 using the hangers 48. The rollers 18 are installed on the roller brackets 36, and a pull rope 28 is tied to end A of the first trough and left remaining and lying inside of the trough. The first trough is then rolled out on the messenger wire far enough to place another trough onto the wire.

Next, the B end of a second trough is hung on the messenger wire with the hanger 48. The A end of the second trough is raised up to the B end of the first trough. The bracket 14 on the A end of the second trough is spread and placed over the pins 50 of the bracket on the B end of the first trough so that the pins 50 extend through the apertures in the opposing bracket. The brackets 14 are secured together by inserting cotter pins 52 into the pins 50. Roller 18 is then installed on the B end of the second trough being installed. The pull rope 28 is inspected to ensure that it remains within and running through the troughs. The trough assembly, now having two troughs, is rolled out on the messenger wire far enough for another section of trough to be installed.

Now, the process for installing the second trough is repeated with additional troughs 12 until the trough assembly traverses the messenger wire 20 and reaches the opposing pole 34 situated for pulling cable 26 across. Once the troughs 12 traverse the entire span of the messenger wire 20, the stabilizer bar 60 is attached between the pole 34 for feeding and the B end of the last trough 12 that is installed.

New cable is pulled through the trough assembly using the combination of the pulley wheels on each pole and the trough assembly. After the cable is pulled through, a lasher or lashing wire is provided. The lasher is attached around cable 26 and to the A end of the first trough that was installed, which will be positioned at the pole 34 where pulling of the cable takes place. As the trough assembly is disassembled in reverse order from the order the troughs were installed, the lasher will be pulled across the project, winding the lasher around the cable and messenger wire to secure the new cable 26 to the messenger wire 20.

1. A medium traversal system comprising: (a) an elongate trough, said trough comprising opposing sides connected by a bottom surface and said sides extending upward from the bottom surface to an opposing top edge of each side, wherein said top edges define an elongate top opening of a channel along the length of the trough; (b) a rolling mechanism, said rolling mechanism having a roller, and said rolling mechanism is attached above and opposing the top opening of the trough and said rolling mechanism is detachable from the trough whereby the trough is connected to a messenger wire and suspended by arranging the messenger wire between the roller and the trough; (c) a plurality of the troughs are linked end to end and said troughs are suspended from the messenger wire whereby the troughs span across the medium and provide an aerial support for cable within the channel of the troughs.

2. The medium traversal system of claim 1, wherein the rolling mechanism comprises opposed apertures attached to the sides of the trough or integrated into the sides of the trough, and a removable roller pin retains the roller in spaced relation to the bottom surface of the trough by insertion of the roller pin through the roller and the apertures.

3. The medium traversal system of claim 2, wherein the rolling mechanism further includes a bracket connected to the sides of the trough and includes opposing retention arm members extending above the top edge of each side, and said opposed apertures are situated in the opposing retention arm members at a position above the top opening of the trough.

4. The medium traversal system of claim 1, further comprising a connecting bracket comprising on a first end of the trough a pair of opposing outwardly extending pins extending perpendicularly outward from each of the opposing sides of the trough, and, on a second end of the trough, the connecting bracket comprising a pair of opposing connecting arms extending longitudinally from each of the opposing sides of the trough and extending past the second end of the trough and having a pair of opposed apertures in the connecting arms for connection to the pair of opposing outwardly extending pins, whereby the plurality of troughs are linked end to end.

5. A method for installing cable across a medium comprising the steps of: (a) providing a messenger wire spanning a medium and attached to a first pole and a second pole, (b) providing a first trough with a roller bracket on both a first end and second end, a hanger on both ends, and bracket pins on the second end, (c) providing a roller for installation on each roller bracket, (d) installing the first trough by hanging the first trough on the messenger wire by the hangers and then installing the rollers on the roller brackets, (e) providing a plurality of a second trough with a connecting bracket on a first end, a roller bracket and a hanger on a second end, and bracket pins the second end, (f) installing the second trough by hanging the second trough on the messenger wire by the hanger and connecting the connecting bracket of the second trough to the bracket pins of the first trough and then installing the roller provided for each roller bracket on the roller bracket of the second trough, (g) repeating the installing of the second trough until the medium is traversed by the plurality of troughs using the plurality of the second troughs by installing each additional second trough by hanging the second trough on the messenger wire by the hanger and connecting the connecting bracket of the second trough to the bracket pins of the previous installed second trough and then installing the roller provided for each roller bracket on the roller bracket of the additional second trough, (h) pulling a cable through the troughs to traverse the medium, (i) attaching a lasher around the cable and the first end of the first trough, and (j) removing the troughs from the messenger wire in the reverse order that they were installed while pulling the lasher across and winding the lasher around the cable and the messenger wire to secure the cable to the messenger wire.
